(19) United States
(12) Patent Application Publication
(10) Pub. No.: US 2025/0048057 A1
(43) Pub. Date: Feb. 6, 2025

(54) VEHICLE CONTROLS AND ALERTS BASED ON WEARABLES

(71) Applicant: Oshkosh Corporation, Oshkosh, WI (US)

(72) Inventor: Brendan Chan, Oshkosh, WI (US)

(73) Assignee: Oshkosh Corporation, Oshkosh, WI (US)

(21) Appl. No.: 18/787,421

(22) Filed: Jul. 29, 2024

Related U.S. Application Data
(60) Provisional application No. 63/529,878, filed on Jul. 31, 2023.

(51) Int. Cl. H04W 4/02; H04W 4/40

(52) U.S. Cl. CPC H04W 4/023; H04W 4/40

(57) ABSTRACT

A position tracking system can include a first position module, a second position module in communication with the first position module, and one or more processing circuits in communication with the first position module and the second position module. The one or more processing circuits can receive a plurality of signals corresponding to communications between the first position module and the second position module, determine a position of a wearable device, detect a change in the position of the wearable device, identify one or more actions performed by an operator, and determine that at least one evaluated action is included in the one or more actions.

### CROSS-REFERENCE TO RELATED PATENT APPLICATIONS

This application claims the benefit of and priority to U.S. Provisional Patent Application No. 63/529,878, filed on Jul. 31, 2023, the entirety of which is hereby incorporated by reference herein.

### BACKGROUND

The present disclosure relates generally to monitoring and alert systems for vehicles. Various vehicles, such as refuse vehicles, mixer vehicles, and/or other vehicle types may be equipped with alarms to notify persons in the vicinity of the vehicle that the vehicle is moving. For example, vehicles may be equipped with a backup alarm that generates sound when to notify persons behind the vehicle that the vehicle is backing up. However, such audible alerts may not always be sufficient to ensure the safety of persons around the vehicle during vehicle operation.

### SUMMARY

One embodiment relates to a vehicle. The vehicle can include one or more processing circuits. The one or more processing circuits can be in communication with a first position module coupled with a first portion of the vehicle and a second position module included in a wearable device. The wearable device can be positioned on an operator of the vehicle. The one or more processing circuits can receive a plurality of signals corresponding to communications between the first position module and the second position module. The one or more processing circuits can also determine, based on the plurality of signals, a position of the wearable device. The one or more processing circuits can also detect, responsive to receipt of a second plurality of signals corresponding to subsequent communication between the first position module and the second position module, a change in the position of the wearable device. The one or more processing circuits can also identify, based on the change in the position of the wearable device, one or more actions performed by the operator, and determine, based on the one or more actions, that at least one evaluated action is included in the one or more actions.

In some embodiments, the one or more processing circuits can receive a third plurality of signals corresponding to communications between the second position module and at least one of the first position module or a third position module coupled with a first portion of a second vehicle. The one or more processing circuits can also determine, based on the third plurality of signals, a first distance between the wearable device and the vehicle, and a second distance between the wearable device and the second vehicle. The one or more processing circuits can also detect, based on the first distance and the second distance, that the operator is positioned at a first point within a predetermined threshold, and transmit, responsive to detection that the operator is positioned at the first point, a signal to the second position module, wherein receipt of the signal causes the wearable device to produce at least one of audible feedback, haptic feedback, or visual feedback to alert the operator.

In some embodiments, the vehicle can include a third position module disposed on a moveable component of the vehicle. The one or more processing circuits can receive a third plurality of signals corresponding to communications between the first position module and at least one of the second position module or the third position module. The one or more processing circuits can also determine, based on the third plurality of signals, a first position of the wearable device relative to the moveable component of the vehicle, and prevent, responsive to a change in the first position of the wearable device, operation of the moveable component.

In some embodiments, the one or more processing circuits can generate, responsive to identification of one or more second actions performed by the operator, an indication of performance of the one or more second actions, and provide the indication of performance of the one or more second actions to the wearable device.

In some embodiments, the one or more processing circuits can determine, based on the one or more actions, that at least one second evaluated action is absent from the one or more actions, and transmit, responsive to determine that the at least one second evaluated action is absent from the one or more actions, a signal to the second position module to cause the wearable device to produce at least one of audible feedback, haptic feedback, or visual feedback to alert the operator.

In some embodiments, the one or more processing circuits can receive a third plurality of signals corresponding to subsequent communications between the first position module and the second position module, and determine, based on the third plurality of signals, a path taken by the operator about the vehicle.

In some embodiments, the change in the position of the wearable device can include one or more second positions of the wearable device. The one or more processing circuits can identify, based on the change in the position of the wearable device, the one or more actions performed by the operator by determining, based on a location of the one or second positions of the wearable device relative to one or more second portions of the vehicle, one or more components of the vehicle proximate to the one or more second positions. The one or more processing circuits can also identify, based on the change in the position of the wearable device, the one or more actions performed by the operator by identifying, based on the one or more components, a plurality of given actions associated with the one or more components, and determining, based on an amount of time spent at the one or more second positions of the wearable device, one or more given actions of the plurality of given actions associated with the amount of time.

In some embodiments, the wearable device can be included in at least one of a hardhat, a high visibility article of clothing, a watch, a band, a strap, or a pin.

In some embodiments, the at least one evaluated action can include at least one of inspecting fasteners coupling tractive elements to the vehicle, inspecting the vehicle for foreign objects, inspecting lighting equipment disposed on the vehicle, performing an equipment function test, or locating identification information disposed on the vehicle.

Some embodiments relate to a position tracking system. The position tracking system can include a first position module coupled with a first portion of a vehicle. The position tracking system can also include a second position module in communication with the first position module. The second position module included in a wearable device, and the wearable device can be positioned on an operator of the vehicle. The position tracking system can also include one or more processing circuits in communication with the first position module and the second position module. The one or more processing circuits can receive a plurality of signals corresponding to communications between the first position module and the second position module. The one or more processing circuits can also determine, based on the plurality of signals, a position of the wearable device. The one or more processing circuits can also detect, responsive to receipt of a second plurality of signals corresponding to subsequent communication between the first position module and the second position module, a change in the position of the wearable device. The one or more processing circuits can also identify, based on the change in the position of the wearable device, one or more actions performed by the operator, and determine, based on the one or more actions, that at least one evaluated action is included in the one or more actions.

One embodiment relates to a vehicle. The vehicle can include one or more processing circuits. The one or more processing circuits can communicate with a first position module coupled with a first portion of the vehicle and a second position module included in a wearable device. The wearable device can be positioned on an operator of the vehicle. The one or more processing circuits can receive a plurality of signals corresponding to communications between the first position module and the second position module. The one or more processing circuits can determine, based on the plurality of signals, a position of the wearable device. The one or more processing circuits can detect, responsive to receipt of a second plurality of signals corresponding to subsequent communication between the first position module and the second position module, a change in the position of the wearable device. The one or more processing circuits can identify, based on the change in the position of the wearable device, one or more actions performed by the operator of the vehicle. The one or more processing circuits can determine, based on the one or more actions, that the one or more actions correspond with at least one evaluated action. The one or more processing circuits can generate, responsive to determination that the one or more actions correspond to the at least one evaluated action, an indication of performance of the at least one evaluated action. The one or more processing circuits can provide, to the wearable device, the indication of the performance of the at least one evaluated action.

One embodiment relates to a vehicle. The vehicle can include one or more processing circuits. The one or more processing circuits can communicate with a first position module coupled with a first portion of the vehicle and a second position module included in a wearable device. The wearable device can be positioned on an operator of the vehicle. The one or more processing circuits can receive a plurality of signals corresponding to communications between the first position module and the second position module. The one or more processing circuits can determine, based on the plurality of signals, a position of the wearable device. The one or more processing circuits can detect, responsive to receipt of a second plurality of signals corresponding to subsequent communication between the first position module and the second position module, a change in the position of the wearable device. The one or more processing circuits can identify, based on the change in the position of the wearable device, one or more actions performed by the operator of the vehicle. The one or more processing circuits can receive a third plurality of signals corresponding to communications between the second position module and a third position module coupled with a first portion of a second vehicle. The one or more processing circuits can determine, based on the third plurality of signals, a first distance between the wearable device and the vehicle, and a second distance between the wearable device and the second vehicle.

One embodiment relates to a position tracking system. The position tracking system can be for a vehicle. The position tracking system can include a first position module. The first position module can couple with a first portion of the vehicle. The position tracking system can include a second position module. The second position module can be included in a wearable device. The wearable device can be positioned on an operator of the vehicle. The position tracking system can include one or more processing circuits. The one or more processing circuits can communicate with the first position module and the second position module. The one or more processing circuits can receive a plurality of signals corresponding to communications between the first position module and the second position module. The one or more processing circuits can determine, based on the plurality of signals, a position of the wearable device. The one or more processing circuits can detect, responsive to receipt of a second plurality of signals corresponding to subsequent communication between the first position module and the second position module, a change in the position of the wearable device. The one or more processing circuits can identify, based on the change in the position of the wearable device, one or more actions performed by the operator. The one or more processing circuits can determine, based on the one or more actions, that at least one evaluated action is included in the one or more actions.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a left side view of a vehicle, according to an exemplary embodiment.

FIG. 2 is a perspective view of a chassis of the vehicle of FIG. 1, according to an exemplary embodiment.

FIG. 3 is a perspective view of the vehicle of FIG. 1 configured as a front-loading refuse vehicle, according to an exemplary embodiment.

FIG. 4 is a left side view of the front-loading refuse vehicle of FIG. 3 configured with a tag axle, according to an exemplary embodiment.

FIG. 5 is a block diagram of a system including the vehicle illustrated in FIG. 3 and a wearable, according to an exemplary embodiment.

FIG. 6 is a block diagram of position tracking system, according to an exemplary embodiment.

FIG. 7 is a block diagram of a system including a tag and an anchor implemented in the position tracking system illustrated in FIG. 6, according to an exemplary embodiment.

FIG. 8 is a perspective view of an environment including the vehicle illustrated in FIG. 3, according to some embodiments.

FIG. 9 is a perspective view of an environment including one or more vehicles, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Vehicles may include components, elements, and/or equipment (e.g., working components, etc.). For example, a refuse vehicle may include an arm assembly. The arm assembly and/or a component thereof may be moveable and/or controllable. For example, the arm assembly may include an actuator in communication with a controller and the controller may transmit signals and/or otherwise control the actuator. To continue this example, the controller may cause the actuator to retract and/or extend (e.g., move) and movement of the actuator may cause a component of the arm assembly to move. The movement of the components of vehicle may result in the components being repositioned and/or relocated relative to the chassis of the refuse vehicle. For example, arms of an arm assembly may be located above the refuse vehicle and movement of actuators may cause the arms to be move towards a front portion of the refuse vehicle.

Movement of components of the vehicle may result in components moving closer to objects and/or obstacles. For example, a tailgate of a vehicle may include at least one open position and at least one closed position. To continue this example, the tailgate may move from the closed position to the open position and the opening (e.g., the tailgate moving from the closed position to the open position) of the tailgate may result in at least a portion of the tailgate moving away from portions of the vehicle. Additionally, the opening of the tailgate may result in the tailgate moving towards an object and/or an object coming into contact with the tailgate. For example, a person may be walking near the tailgate and the person may not realize that the tailgate has been opened. To continue this example, the tailgate may come into contact with the person.

Some technical solutions of the present application include communication devices and/or position modules that may communicate with one another for use in determining positions. The positions may be relative to a vehicle. For example, the positions may be relative to a position of a refuse vehicle. To continue this example, the refuse vehicle may include one or more position modules and a placement and/or location of the position modules (on the refuse vehicle) may establish setpoints and/or reference points. As another example, the position modules may exchange data to one or more processing circuits and the processing circuits may determine positions of the position modules.

The communication devices and/or the position modules may be disposed on moveable elements of vehicles and/or disposed on wearables. For example, a position module may be disposed within and/or included in a wearable device and the wearable device may be included in a hardhat. As another example, a position module may be disposed on lift forks of a vehicle. The position modules may be in communication with one another. For example, a first position module (e.g., onboard the vehicle) may communicate with a second position module (e.g., disposed on a wearable device) by transmitting signals to one another. As another example, position modules may communicate with one another by transmitting short-range signals. To continue this example, the short-range signals may include signals in the Ultra-Wideband (UWB) spectrum.

Data pertaining to communications between position modules may be provided to a computing system (e.g., a computer, a server, processing circuits, etc.) and the computing system may detect a position of the position modules. For example, the computing system may detect that a position module located within a hardhat is positioned proximate to an arm assembly of a vehicle based one communication between the position module and a position module located proximate to the arm assembly. The computing system may prevent movement of the arm assembly and/or the computing system may transmit signals to warn an individual that is wearing the hardhat. For example, the computing system may control a controller to halt and/or stop movement of an actuator that is causing the arm assembly to move. As another example, the computing system may transmit a signal to the position module located with the hardhat causing an audible and/or haptic signal to be produced.

The computing system may also determine actions that have been performed by individuals associated with a device and/or wearing a device including a position module. For example, an operator of a refuse vehicle may have one or more duties and/or checklist items to perform prior to operation of the refuse vehicle. To continue this example, the duties may include checking the refuse vehicle for debris, checking the refuse vehicle for identification (e.g., license plate, vehicle number, etc.). The computing system may determine and/or monitor changes in positions of the device (and/or the position module) and the computing system may, based on the positions, determine actions performed by the operator. For example, the computing system may determine that positions of the position module, relative to the refuse vehicle, indicating that the operator examined and/or looked for a license plate on the vehicle. As another example, the computing system may determine that operator walked around the refuse vehicle and determining that the operator walked around the refuse vehicle may indicate that the operator looked for debris.

### Overall Vehicle

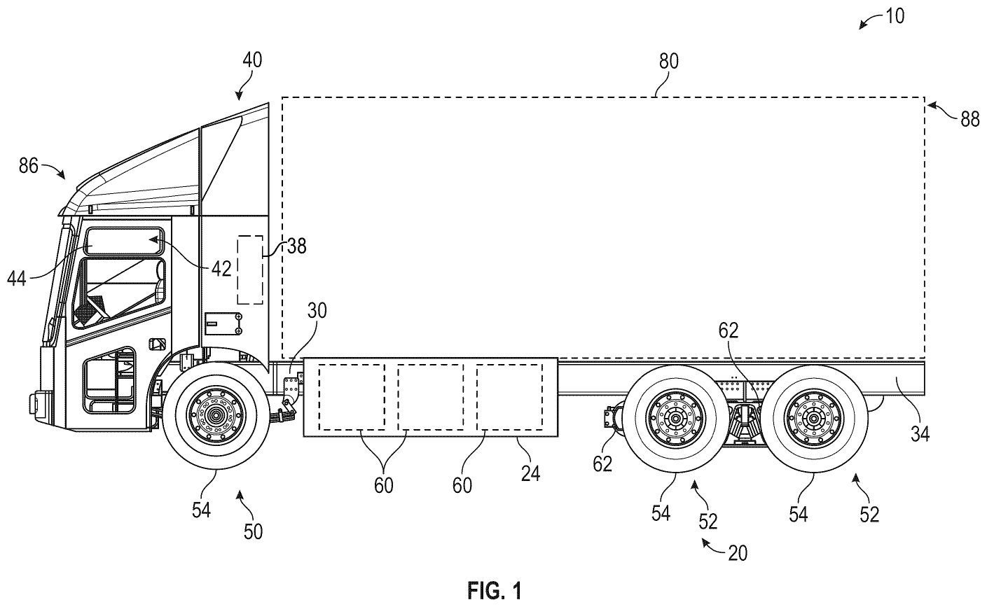

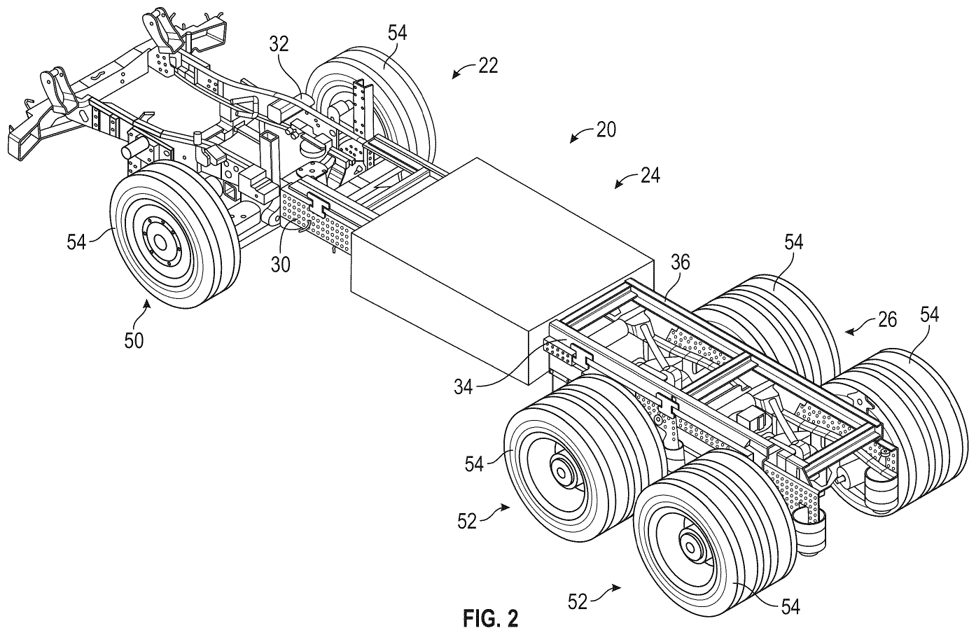

Referring to FIGS. 1 and 2, a vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks fuel tanks. By way of yet another example, the middle section 24 may define a void space or storage volume that can be filled by a user.

A cabin, operator compartment, or body component, shown as cab 40, is coupled to a front-end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the axle front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

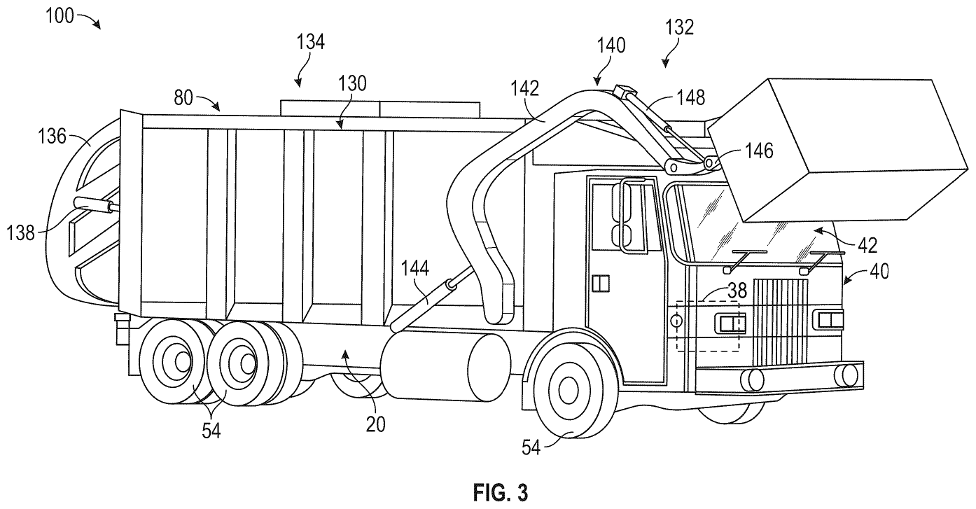

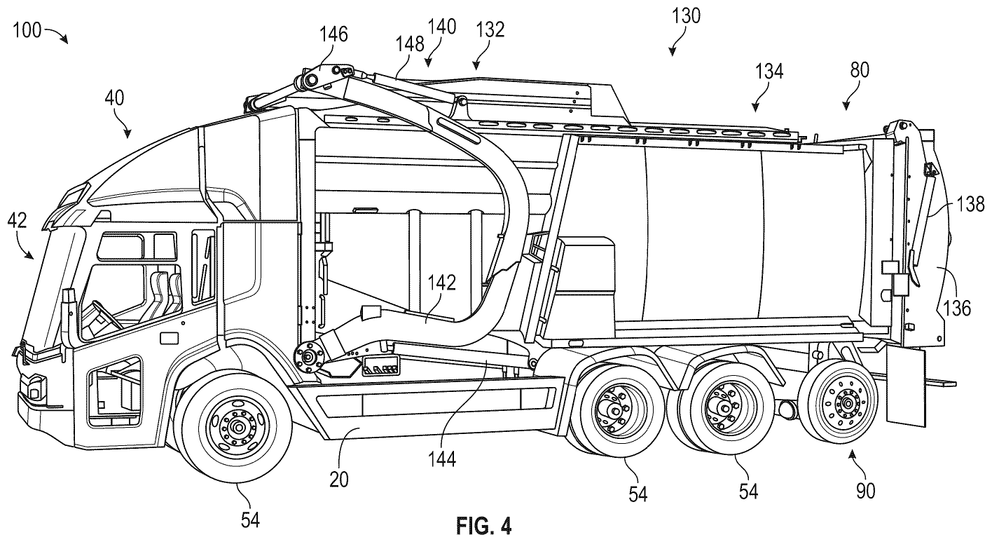

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, the vehicle 10 may be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-4 illustrate various examples of how the vehicle 10 may be configured for specific applications. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

The vehicle 10 includes a controller 38 that is configured to operate any of the motors, actuators, components, implements, and/or elements of the various vehicles described herein. For example, the application kit 80 may be controllable by the controller 38. In some embodiments, the controller 38 may receive sensory input from sensors disposed on the vehicle 10. The controller 38 may generate control signals to operator any of the vehicle components described herein. For example, the controller 38 may generate control signals to control the drive motors 62.

### Front-Loading Refuse Vehicle

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a front-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned reward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck).

As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively coupled the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

### Wearable Devices

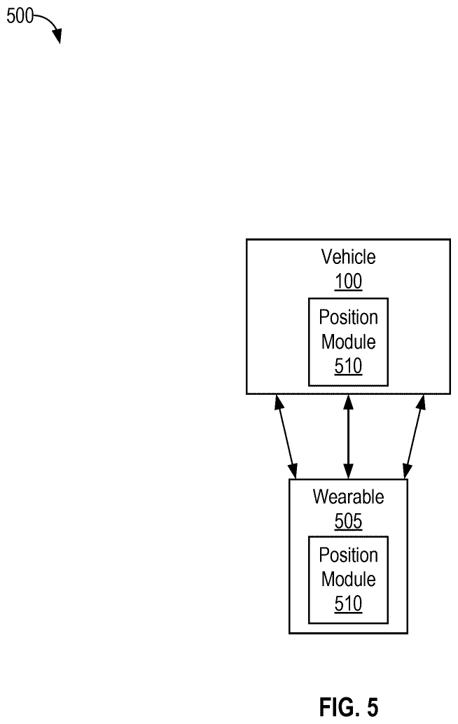

FIG. 5 depicts a block diagram of a system 500, according to some embodiments. Each system and/or component of the system 500 can include one or more processors, memory, network interfaces, communication interfaces, and/or user interfaces. Memory can store programming logic that, when executed by the processor, controls the operation of the corresponding computing system or device. Memory can also store data in databases. The network interfaces can allow the systems and/or components of the system 500 to communicate wirelessly. The communication interfaces can include wired and/or wireless communication interfaces and the systems and/or components of the system 500 can be connected via the communication interfaces. The various components in the system 500 can be implemented via hardware (e.g., circuitry), software (e.g., executable code), or any combination thereof. Systems, devices, and components in FIG. 5 can be added, deleted, integrated, separated, and/or rearranged.

The system 500 may include at least one vehicle 100 and at least one wearable and/or wearable device 505. The vehicle 100 may include the various vehicles described herein. For example, the vehicle 100 may include and/or be implemented as the vehicle 10. In some embodiments, the vehicle 100 may include additional vehicles, and/or vehicle types. For example, the vehicle 100 may include and/or be implemented as a boom lift. The vehicle 100 and the wearable device 505 are shown to include position module 510. For example, the vehicle 100 may include a first position module 510 and the wearable device 505 may include a second position module 510.

The position modules 510 may communicate with one another. For example, the position modules 510 may communicate via wireless signals. In some embodiments, the wireless signals may include short-range signals. For example, the short-range signals may include signals in the Ultra-Wideband (UWB) spectrum. The short-range signals may also include other possible wired and/or wireless signal transmission. For example, the short-range signals may include signals transmitted via a Controller Area Network (CAN). As describe herein signals, wireless signals, short-range signals, and/or various other signals described herein may include at least one transmission technique and/or transmission device described herein.

In some embodiments, the wearable device 505 includes and/or is implemented as at least one of a hardhat, a high visibility article of clothing, a watch, a band, a strap, or a pin. For example, the wearable device 505 can be disposed and/or otherwise including a hardhat. The wearable device 505 may be worn by at least one individual. For example, the wearable device 505 may be worn by an operator of the vehicle 100. The wearable device 505 may also be worn by at least one individual located at and/or proximate to a post-collection site. For example, the wearable device 505 may be worn by a refuse collection worker.

The position modules 510 may include and/or communicate with one or more processing circuits. The processing circuits may include at least one processor and memory. The processing circuits may include various devices, components, hardware, software, etc. described herein. The processing circuits may receive the various signals described herein. The processing circuits may also receive signals corresponding to communications between the position modules 510. For example, the first position module 510 may transmit a first signal to the second position module 510, the second position module 510 may transmit a second signal to the first position module 510, and the first position module 510 may transmit, to the processing circuits, information pertaining to the first signal and the second signal (e.g., communications between the first position module 510 and the second position module 510).

The processing circuits may generate, detect, identify, and/or otherwise determine a distance and/or a position of the vehicle 100 relative to the wearable device 505 and/or the wearable device 505 relative to the vehicle 100. For example, a position of the vehicle 100 may be considered an origin and/or a default position and the position of the wearable device 505 may be determined relative to position of the vehicle 100. As another example, the vehicle 100 may include one or more additional position modules 510 disposed on various portions of the vehicle 100. The one or more additional position modules 510 may be disposed at fixed portions and/or known positions of the vehicle 100 (e.g., portions of the vehicle 100 that may stay relative unchanged). The processing circuits may determine the position of the wearable device 505 based on various aspects of the signals provided to the processing circuits. For example, the processing circuits may know a given transmission speed of the signals and then determine the position of the wearable device 505 based on how long it took for the position modules 510 to receive the signals.

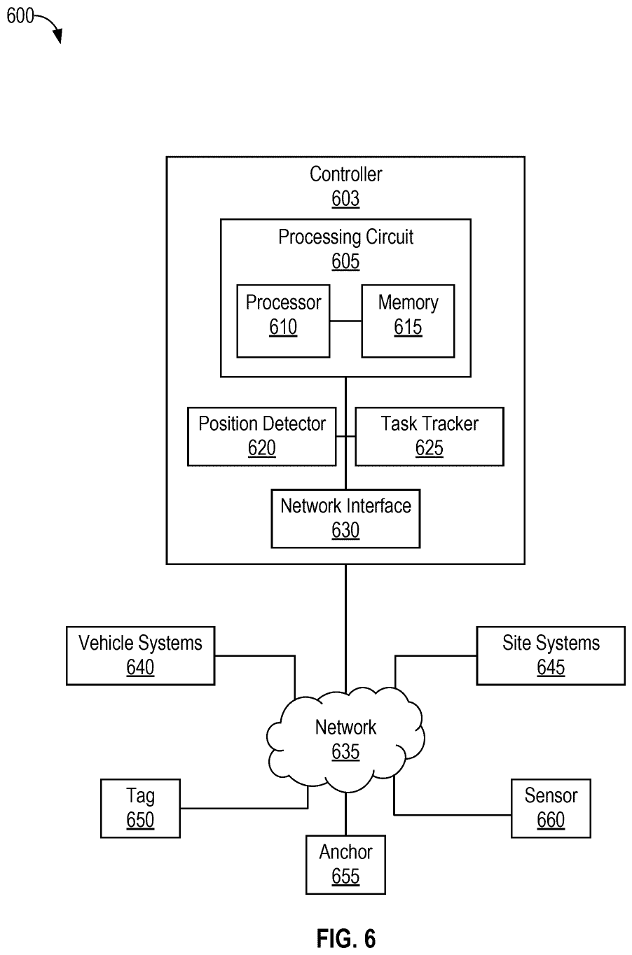

FIG. 6 depicts a block diagram of a position tracking system 600, according to some embodiments. Each system and/or component of the position tracking system 600 can include one or more processors, memory, network interfaces, communication interfaces, and/or user interfaces. Memory can store programming logic that, when executed by the processor, controls the operation of the corresponding computing system or device. Memory can also store data in databases. The network interfaces can allow the systems and/or components of the position tracking system 600 to communicate wirelessly. The communication interfaces can include wired and/or wireless communication interfaces and the systems and/or components of the position tracking system 600 can be connected via the communication interfaces. The various components in the position tracking system 600 can be implemented via hardware (e.g., circuitry), software (e.g., executable code), or any combination thereof. Systems, devices, and components in FIG. 6 can be added, deleted, integrated, separated, and/or rearranged.

The position tracking system 600 includes at least one controller 603, at least one network 635, vehicle system 640, site systems 645, at least one tag 650, at least one anchor 655, and at least one sensor 660. The network 635 may include at least one of a local area network (LAN), wide area network (WAN), telephone network (such as the Public Switched Telephone Network (PSTN)), CAN, wireless link, intranet, the Internet, a cellular network and/or combinations thereof. In some embodiments, the network 635 may include and/or encompass signals transmitting via the UWB spectrum.

The vehicle systems 640 may include and/or be implemented as at least one of the various systems and/or components described herein. For example, the vehicle systems 640 may include lift assembly 140. The vehicle systems 640 may be controllable by at least one of the electrical devices and/or circuits described herein. For example, the controller 38 may control the vehicle systems 640. The site systems 645 may include and/or be implemented at various pieces of equipment and/or buildings that may be located proximate to a post-collection site. For example, the site systems 645 may include composting equipment, refuse equipment, etc. The post-collection site may refer to and/or include at least one of a facility, a site, and/or a building that receives and/or handles refuse that is collected by various vehicles. In some embodiments, the post-collection site may include a construction site, a commercial building, a residential location, a parking lot, and/or among various other possible sites.

The tags 650 may include and/or be implemented with the position modules 510. The tags 650 may refer to devices and/or components that are disposed and/or included in one or more moveable objects. For example, the tags 650 may be included in position modules 510 that are included in the wearable devices 505. The tags 650 may be included in position modules 510 that are coupled with various moveable components of the vehicle 100 (e.g., the lift assembly 140, the tailgate 136, etc.) The anchors 655 may include and/or be implemented with the position modules 510. The anchors 655 may refer to devices and/or components that are placed, position, affixed, and/or otherwise located on portions and/or elements of the vehicle 100 that a fixed (e.g., the chassis 20, the cab 40, the refuse compartment 130, etc.). In some embodiments, positions of the anchors 655 (e.g., where the anchors 655 are coupled with and/or disposed on the vehicle 100) may be used as one or more reference points. For example, by knowing the positions of the anchors 655, one or more processing circuits may determine positions of the tags 650 based on an amount of time that is takes for various signals to be received, by the anchors 655, and/or an amount of time that is takes for various signals to be transmitted to the tags 650.

The sensors 660 may include at least one of proximity sensors, cameras, video devices, location devices, motion detectors, position sensors, object detection devices, and/or various other possible sensors. For example, the sensors 660 may include cameras disposed on various portions of the vehicle 100. The sensors 660 may also include object detection devices that detect objects (e.g., people, obstacles, vehicles, etc.). The sensors 660 may detect an individual (e.g., the operator of the vehicle 100) and the sensors 660 may record, measure, and/or otherwise determine a duration of time (e.g., how long the individual was detected). The duration of time may indicate an amount of time that was spent and/or the elapsed by the individual with respect to a given portion of the vehicle. For example, the duration of time may indicate that the individual spent 60 seconds examining a front right wheel of the vehicle 100.

In some embodiments, the controller 603 may be similar to or the same as the controller 38. In some embodiments, the controller 603 is a secondary and/or separate controller from the controller 38. For example, the controller 38 may be configured to generate control signals for the various components of the vehicle 100, while the controller 603 may be configured to determine positions of the position modules 510. In some embodiments, the controller 603 may be implemented within at least one of the position modules 510, the tags 650, and/or the anchors 655. For example, a first position module 510 may include the controller 603.

The controller 603 may communicate with the various systems, devices, and/or components shown in FIG. 6. For example, the controller 603 may transmit control signals to the vehicle systems 640. The controller 603 may also receive signals corresponding to communications between the tags 650 and the anchors 655. The controller 603 may also receive sensor information collected by the sensors 660.

The controller 603 includes processing circuit 605, position detector 620, task tracker 625, and network interface 630. The processing circuit 605 includes at least one processor 610 and memory 615. The processing circuit 605 may include the various processing circuits described herein. It will be appreciated that these components can be implemented using a variety of different types and quantities of processors and memory. For example, the processors 610 404 may include at least one of a general purpose processor, an application specific integrated circuit (ASIC), one or more field programmable gate arrays (FPGAs), a group of processing components, or other suitable electronic processing components. The processors 610 may be communicatively coupled to memory 615. Additionally, it should be understood that, as discussed herein, a processing circuit, a processing unit and/or memory may be implemented using multiple processors and/or memories in various embodiments. All such implementations are contemplated within the scope of the present disclosure.

Memory 615 may include one or more devices (e.g., memory units, memory devices, storage devices, etc.) for storing data and/or computer code for completing and/or facilitating the various processes described in the present disclosure. Memory 615 may include random access memory (RAM), read-only memory (ROM), hard drive storage, temporary storage, non-volatile memory, flash memory, optical memory, or any other suitable memory for storing software objects and/or computer instructions. Memory 615 may include database components, object code components, script components, or any other type of information structure for supporting the various activities and information structures described in the present disclosure. Memory 615 may be communicably connected to the processors 610 and memory 615 may include computer code for executing (e.g., by the processors 610) one or more processes described herein. For example, the processors 610 may determine at least one position of the wearable device 505.

The network interface 630 may refer to and/or include at least one network communication devices, network interfaces, and/or other possible communication interfaces. The network interface 630 may include wired or wireless communications interfaces (e.g., jacks, antennas, transmitters, receivers, transceivers, wire terminals, etc.) for conducting data communications with the sensors 660, the anchors 655, the tags 650, the site systems 645, and/or the vehicle systems 640. The network interface 630 may include direct (e.g., local wired or wireless communications) and/or via a communications network (e.g., the network 635). For example, the network interface may include an Ethernet card and port for sending and receiving data via an Ethernet-based communications link or network. The network interface 630 may also include a Wi-Fi transceiver for communicating via a wireless communications network (e.g., the network 635). The network interface 630 may include a power line communications interface. The network interface 630 may include an Ethernet interface, a USB interface, a serial communications interface, and/or a parallel communications interface. The network interface 630 may interface with, interact with, and/or otherwise communicate with at least one component, system, and/or device described herein. For example, the network interface 630 may communicate with the position modules 510 via the UWB spectrum.

The network interface 630 may receive a plurality of signals corresponding to communications between position modules. For example, the first position module 510 and the second position module 510 may communicate with one another and signals corresponding to their communications may be provided to the network interface 630. In some embodiments, the communications between the first position module 510 and the second position module 510 may include transmitting signals in the UWB spectrum. In some embodiment, the plurality of signals received by the network interface 630 may also be transmitted in the UWB spectrum. In some embodiments, the plurality of signals may be transmitted via at least one of the various techniques described herein. The network interface 630 may provide the plurality of signals to at least one of the components of the position tracking system 600. For example, the network interface 630 may provide the signals to the position detector 620.

The position detector 620 may determine, based on the plurality of signals, a position of a wearable device. For example, the position detector 620 may determine a position of the wearable device 505. The position of the wearable device 505 may be relative to the vehicle 100. For example, the position detector 620 may determine, based on anchors 655 disposed on the vehicle 100 and known positions of the anchors 655, that the wearable device 505 is positioned towards a front portion of the vehicle 100. The position detector 620 may also determine a distance between the wearable device 505 and the vehicle 100 (e.g., how far and/or close is the wearable device 505 to the vehicle 100).

The position detector 620 may detect, responsive to receipt of a second plurality of signals corresponding to subsequent communication between the first position module 510 and the second position module 510, a change in the position of the wearable device 505. For example, the first position module 510 and the second position module 510 may communicate, with one another, continuously and/or semi-continuously and the communications may be provided to the position detector 620. The position detector 620 may determine, from subsequent signals corresponding to communications, positions of the wearable device 505. For example, as the position detector 620 receives signals, the position detector 620 may determine one or more positions of the wearable device 505. The position detector 620 may detect the change in the position of the wearable device 505 responsive to the position detector 620 determining that a position, determined by the position detector 620, of the wearable device 505 is different from a previously established current position of the wearable device 505.

The task tracker 625 may identify, based on the change in the position of the wearable device 505, one or more actions performed by the operator. For example, the change in the position of the wearable device may indicate that the operator has moved from a front region of the vehicle 100 to a side region of the vehicle. To continue this example, the operator moving to the side region of the vehicle may indicate that the operator of the vehicle has examined the front region of the vehicle. In some embodiments, the one or more actions may include at least one of inspecting fasteners coupling tractive elements to the vehicle, inspecting the vehicle for foreign objects, inspecting lighting equipment disposed on the vehicle, performing an equipment function test, and/or locating identification information disposed on the vehicle. For example, the operator may check to ensure that brake lights disposed on the vehicle are operational (e.g., turn on when brake is activated).

The task tracker 625 may determine, based on the one or more actions, that at least one evaluated action is included in the one or more actions. For example, prior to operation of the vehicle 100, the operator may have one or more checklist items to perform (e.g., evaluated actions to perform). To continue this example, the checklist items may include the one or more actions and/or evaluated actions described herein. In some embodiments, the task tracker 625 may determine that the evaluated action is included in the one or more actions (e.g., the evaluated action was performed) responsive to analysis of the plurality of signals and/or various other information collected by the vehicle 100 (e.g., the sensors 660). For example, the task tracker 625 may determine an amount of time that the operator spent at the front region of the vehicle 100. The task tracker 625 may also determine a distance between the vehicle 100 and the wearable device 505 to determine that the operator inspected a front license plate of the vehicle 100.

The network interface 630 may receive one or more signals corresponding to communication between the second position module 510 and at least one of the first position module 510 or a third position module 510 coupled with a second vehicle 100. For example, the vehicle 100 and the second vehicle 100 may be disposed, position, located, and/or otherwise disposed proximate to one another. The position of the first vehicle 100 and the second vehicle 100 may allow for the second position module 510 to communicate with the first position module 510 and the third position module. The subsequent communications may be provided to the network interface 630.

The task tracker 625 may determine, based on the one or more signals, a first distance between the wearable device 505 and the vehicle 100, and a second distance between the wearable device 505 and the second vehicle 100. For example, the task tracker 625 may determine that the wearable device 505 is five feet (e.g., the first distance) from the vehicle 100 and that the wearable device 505 is nine feet (e.g., the second distance) from the second vehicle 100.

The task tracker 625 may detect, based on the first distance and the second distance, that the operator is positioned at a first point within a predetermined threshold. For example, the task tracker 625 may determine that the wearable device 505 is position towards a front region (e.g., first point) of the second vehicle 100 and that wearable device 505 being nine feet from the second vehicle 100 is within the predetermined threshold (e.g., how close the wearable device 505 may be to the second vehicle 100). In some embodiments, the predetermined threshold may be based on whether the second vehicle 100 is running (e.g., the vehicle is on). For example, when the second vehicle 100 is running the predetermined threshold may be a first value and when the second vehicle 100 is off the predetermined threshold may be a second value. The predetermined threshold may also be based on one or more operations of the vehicle. For example, the predetermined threshold may be a first value when the lift assembly 140 is operating and the predetermined threshold may be a second value when the vehicle is backing up.

The network interface 630 may transmit, responsive to detection that the operator is positioned at the first point, a signal to the second position module 510. For example, the network interface 630 may transmit a control signal to the second position module 510 to indicate that the operator is positioned at the first point. In some embodiments, the second position module 510 receiving the signal may cause the second position module 510 to produce at least one of audible feedback, haptic feedback, or visual feedback to alert the operator. For example, the wearable device 505 may include at least one of an audio device, a haptic device, and/or a lighting element and the signal transmitted by the network interface 630 may cause the various devices to produce feedback. In some embodiments, the signal may cause the wearable device 505 to vibrate, shack, and/or otherwise move to provide haptic feedback to the operator.

In some embodiments, the vehicle 100 may include a third position module 510. The third position module 510 may be disposed on a moveable component of the vehicle 100. For example, the third position module 510 may be disposed on the lift forks 146. In some embodiments, the third position module 510 may include the tags 650.

The network interface 630 may receive one or more signals corresponding to communications between the first position module and at least one of the second position module 510 or the third position module 510. In some embodiments, the third position module 510 may be in an idle and/or standby status when the lift forks 146 are inactive (e.g., not moving) and a control signal transmitted to the lift assembly 140 may also active the third position module 510. The third position module 510 and the second position module 510 may transmit signals to the first position module 510 and the first position module 510 may transmit, to the network interface 630, signals corresponding to the communications.

The position detector 620 may determine, based on the one or more signals, a first position of the wearable device 505 relative to the moveable component of the vehicle 100. For example, the moveable component of the vehicle 100 may be the tailgate 136 and the position detector 620 may determine the position of the wearable device 505 relative to the tailgate 136.

The controller 603 may prevent, responsive to a change in the first position of the wearable device 505, operation of the moveable component. For example, the position detector 620 may detect that the wearable device 505 is approaching and/or otherwise proximate to the tailgate 136 as the tailgate 136 is opening. To continue this example, the position detector 620 may transmit an indication that the wearable device 505 is approaching the tailgate 136 and the network interface 630 may transmit a control signal that prevents operation of the tailgate 136.

The task tracker 625 may generate, responsive to identification of one or more second actions performed by the operator, an indication of performance of the one or more second actions. For example, the task tracker 625 may document, tally, and/or otherwise record an indication that the one or more second actions were performed. The network interface 630 may provide the indication of performance of the one or more second actions to the wearable device. For example, the network interface 630 may transmit a signal to the wearable device 505 that causes the wearable device to produce an audible message listing the one or more second actions.

The task tracker 625 may determine, based on the one or more actions, that at least one second evaluated action is absent from the one or more actions. For example, the task tracker 625 may determine that the operator did not check the lug nuts for a front right wheel of the vehicle 100. The network interface 630 may transmit, responsive to determine that the at least one second evaluated action is absent from the one or more actions, a signal to the second position module 510. The network interface 630 transmitting the signal may cause the wearable device 505 to produce at least one of audible feedback, haptic feedback, or visual feedback to alert the operator. For example, the wearable device 505 may produce an audible message indicating that the operator forgot to check the lug nuts.

The position detector 620 may determine, based on one or more signals, a path taken by the operator of the vehicle 100. For example, the position detector 620 may overlay, combine, and/or otherwise link positions of the wearable device 505 to generate the path taken by the operator of the vehicle 100. The path taken by the operator of the vehicle 100 may include the operator moving around the vehicle 100, the operator traversing an environment including the vehicle 100, and/or the operator enter and/or exiting various portions of the vehicle 100.

In some embodiments, the change in the position of the wearable device 505 may include one or more second position of the wearable device 505. For example, the change in the position of the wearable device 505 may include the wearable device moving from the position to a second position. In some embodiments, the position detector 620 may determine the one or more actions performed by the operator by determining, based on a location of the one or second positions of the wearable device relative to one or more second portions of the vehicle, one or more components of the vehicle proximate to the one or more second positions. For example, the position detector 620 may determine that the wearable device 505 is position towards a side arm assembly of the vehicle 100.

The position detector 620 may also determine the one or more actions performed by the operator by identifying, based on the one or more components, a plurality of given actions associated with the one or more components. For example, the position detector 620 may determine that operator is inspecting an actuator that controls and/or moves the arm assembly.

The position detector 620 may also determine the one or more actions performed by the operator by determining, based on an amount of time spent at the one or more second positions of the wearable device, one or more given actions of the plurality of given actions associated with the amount of time. For example, the position detector 620 may determine that the wearable device 505 was position proximate to the arm assembly of the vehicle 100 for two minutes and two minutes is an amount of time associated with examining the arm assembly.

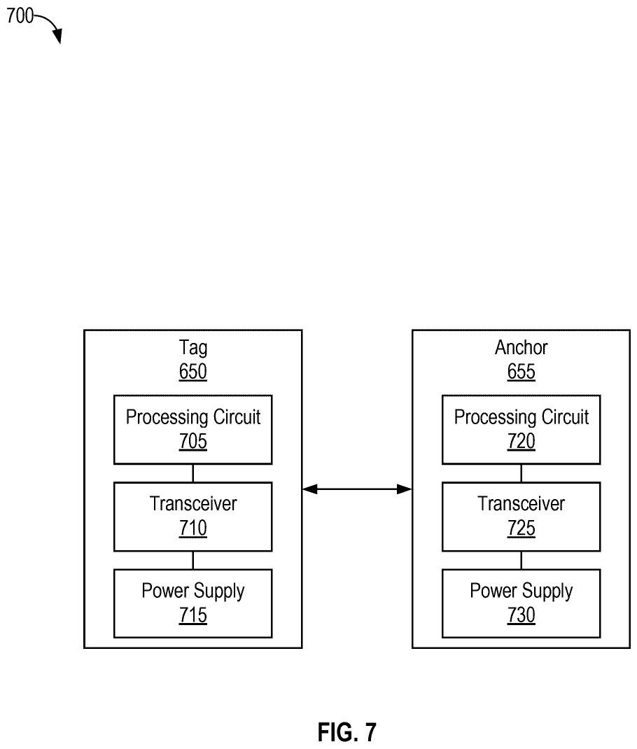

FIG. 7 is a block diagram of a system 700, according to some embodiments. The system 700 includes the tags 650 and the anchors 655. The tags 650 may include processing circuit 705, transceiver 710, and power supply 715. The anchors 655 may include processing circuit 720, transceiver 725, and power supply 730. The processing circuits 705, 720 may include at least one of the various processing circuits described herein. For example, the processing circuits 705, 720 may include processing circuit 605. The transceivers 710,725 may include at least one of the various communication devices and/or components described herein. For example, the transceiver 710, 725 may include the network interface 630. The power supplies 715, 730 may include at least one energy storage device. For example, the power supplies 715, 730 may include batteries. The power supplies 715,730 may provide power to the various components of the tags 650 and/or the anchors 655. The tags 650 and/or the anchors 655 may include at least one component similar to that of the controller 603. For example, the tags 650 may include the position detector 620.

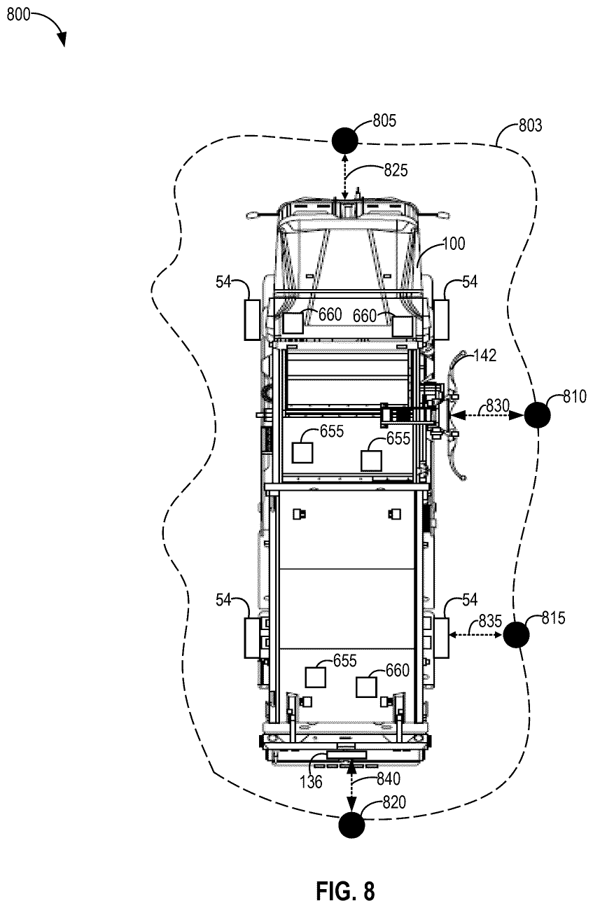

FIG. 8 depicts a perspective view of an environment 800, according to some embodiments. The environment 800 includes the vehicle 100. The environment 800 may include and/or be associated with a post-collection site and/or a storage lot. For example, the environment 800 may include a parking spot for the vehicle 100. FIG. 8 depicts an example of a path 803. The path 803 may be generated and/or determined by the controller 603. The path 803 includes a plurality of points (e.g., points 805, 810, 815, and 820). The plurality of points may include one or more positions of the wearable device 505. The path 803 may reference and/or indicate the operator's movements between points (e.g., how the operator moved from point 805 to 810). Point 805 is shown to a distance 825 away from a front region of the vehicle 100. Point 810 is shown to be a distance 830 away from the lift arms 142. Point 815 is shown to be a distance 835 from a rear right wheel and tire assembly 54. Point 820 is shown to be a distance 840 away from a rear portion of the vehicle 100.

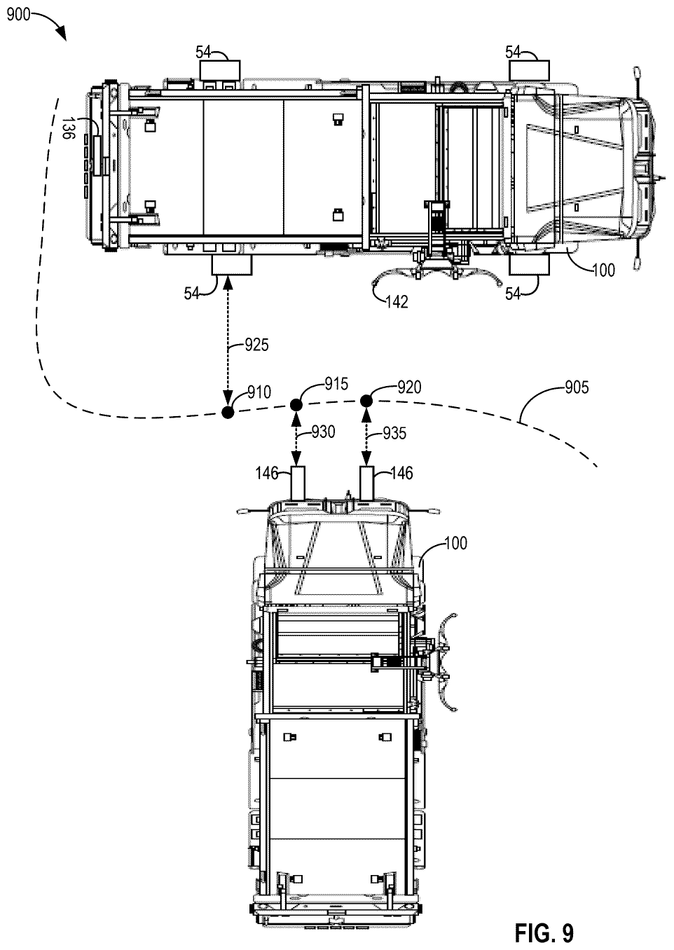

FIG. 9 depicts a perspective view of an environment 900, according to some embodiments. In some embodiments, the environment 900 may include the environment 800. In some embodiments, the environment 900 includes a post-collection site having a plurality of vehicles 100. For example, FIG. 9 depicts an example of the environment 900 including a first vehicle 100 and a second vehicle 100. FIG. 9 depicts an example of a path 905. The path 905 includes a plurality of points (e.g., points 910, 915, and 920). The path 905 may include the path 803. The path 905 may also be a separate path taken by the operator. Point 910 is shown to be a distance 925 away from the rear right wheel and tire assembly 54 of the first vehicle 100. Point 915 is shown to be a distance 930 away from a first lift fork 146 of the second vehicle 100. Point 920 is shown to be a distance 935 away from a second lift fork 146.

In some embodiments, at least one of the points shown in FIG. 9 may include a position of the wearable device 505. In some embodiments, the points shown in FIG. 9 may include positions that are within the predetermined threshold. For example, the point 915 may be within the predetermined threshold responsive to the second vehicle 100 moving. In some embodiments, the wearable device 505 being located at the point 915 may cause the controller 603 to transmit signals to the second vehicle 100 to prevent the second vehicle 100 from continuing to move towards the wearable device 505.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A vehicle, comprising:
one or more processing circuits in communication with a first position module coupled with a first portion of the vehicle and a second position module included in a wearable device, the wearable device configured to be positioned on an operator of the vehicle; and
the one or more processing circuits configured to:
receive a plurality of signals corresponding to communications between the first position module and the second position module;
determine, based on the plurality of signals, a position of the wearable device;
detect, responsive to receipt of a second plurality of signals corresponding to subsequent communication between the first position module and the second position module, a change in the position of the wearable device;
identify, based on the change in the position of the wearable device, one or more actions performed by the operator of the vehicle;
determine, based on the one or more actions, that the one or more actions correspond with at least one evaluated action;
generate, responsive to determination that the one or more actions correspond to the at least one evaluated action, an indication of performance of the at least one evaluated action; and
provide, to the wearable device, the indication of the performance of the at least one evaluated action.

2. The vehicle of claim 1, the one or more processing circuits further configured to:
receive a third plurality of signals corresponding to communications between the second position module and a third position module coupled with a first portion of a second vehicle;
determine, based on the third plurality of signals, a first distance between the wearable device and the vehicle;
determine, based on the third plurality of signals, a second distance between the wearable device and the second vehicle;
detect, based on the first distance and the second distance, that the operator of the vehicle is positioned at a first point within a predetermined threshold; and
transmit, responsive to detection that the operator is positioned at the first point, a signal to the second position module, wherein receipt of the signal causes the wearable device to produce at least one of audible feedback, haptic feedback, or visual feedback to alert the operator.

3. The vehicle of claim 1, further comprising:
a third position module disposed on a moveable component of the vehicle; and
the one or more processing circuits further configured to:
receive a third plurality of signals corresponding to communications between the first position module and the third position module;
determine, based on the third plurality of signals, a first position of the wearable device relative to the moveable component of the vehicle; and
prevent, responsive to a change in the first position of the wearable device, operation of the moveable component.

4. The vehicle of claim 1, the one or more processing circuits further configured to:
determine, based on the one or more actions, that at least one second evaluated action is absent from the one or more actions; and
transmit, responsive to determination that the at least one second evaluated action is absent from the one or more actions, a signal to the second position module to cause the wearable device to produce at least one of audible feedback, haptic feedback, or visual feedback to alert the operator.

5. The vehicle of claim 1, the one or more processing circuits further configured to:
receive a third plurality of signals corresponding to subsequent communications between the first position module and the second position module; and
determine, based on the third plurality of signals, a path taken by the operator about the vehicle.

6. The vehicle of claim 1, wherein the change in the position of the wearable device includes one or more second positions of the wearable device, and wherein the one or more processing circuits are configured to identify the one or more actions performed by the operator by:
determining, based on a location of the one or more second positions of the wearable device relative to one or more second portions of the vehicle, one or more components of the vehicle proximate to the one or more second positions;
identifying, based on the one or more components, a plurality of actions associated with the one or more components; and
determining, based on an amount of time spent at the one or more second positions of the wearable device, respective actions of the plurality of actions associated with the amount of time.

7. The vehicle of claim 1, wherein the wearable device is included in at least one of a hardhat, a high visibility article of clothing, a watch, a band, a strap, or a pin.

8. The vehicle of claim 1, wherein the at least one evaluated action includes at least one of:
inspecting fasteners coupling tractive elements to the vehicle;
inspecting the vehicle for foreign objects;
inspecting lighting equipment disposed on the vehicle;
performing an equipment function test; or
locating identification information disposed on the vehicle.

9. A vehicle, comprising:
one or more processing circuits in communication with a first position module coupled with a first portion of the vehicle and a second position module included in a wearable device, the wearable device configured to be positioned on an operator of the vehicle; and
the one or more processing circuits configured to:
receive a plurality of signals corresponding to communications between the first position module and the second position module;
determine, based on the plurality of signals, a position of the wearable device;
detect, responsive to receipt of a second plurality of signals corresponding to subsequent communication between the first position module and the second position module, a change in the position of the wearable device;
identify, based on the change in the position of the wearable device, one or more actions performed by the operator of the vehicle;
receive a third plurality of signals corresponding to communications between the second position module and a third position module coupled with a first portion of a second vehicle; and
determine, based on the third plurality of signals, a first distance between the wearable device and the vehicle, and a second distance between the wearable device and the second vehicle.

10. The vehicle of claim 9, the one or more processing circuits further configured to:
detect, based on the first distance and the second distance, that the operator is positioned at a first point within a predetermined threshold; and
transmit, responsive to detection that the operator is positioned at the first point, a signal to the second position module, wherein receipt of the signal causes the wearable device to produce at least one of audible feedback, haptic feedback, or visual feedback to alert the operator.

11. The vehicle of claim 9, comprising:
a fourth position module disposed on a moveable component of the vehicle; and
the one or more processing circuits further configured to:
receive a fourth plurality of signals corresponding to communications between the first position module and the fourth position module;
determine, based on the fourth plurality of signals, a first position of the wearable device relative to the moveable component of the vehicle; and
prevent, responsive to a change in the first position of the wearable device, operation of the moveable component.

12. The vehicle of claim 9, the one or more processing circuits further configured to:
generate, responsive to identification of one or more second actions performed by the operator, an indication of performance of the one or more second actions; and
provide the indication of performance of the one or more second actions to the wearable device.

13. The vehicle of claim 9, the one or more processing circuits further configured to:
determine, based on the one or more actions, that at least one evaluated action is absent from the one or more actions; and
transmit, responsive to determination that the at least one evaluated action is absent from the one or more actions, a signal to the second position module to cause the wearable device to produce at least one of audible feedback, haptic feedback, or visual feedback to alert the operator.

14. The vehicle of claim 9, the one or more processing circuits further configured to:
receive a fourth plurality of signals corresponding to subsequent communications between the first position module and the second position module; and
determine, based on the third plurality of signals, a path taken by the operator about the vehicle.

15. The vehicle of claim 9, wherein the change in the position of the wearable device includes one or more second positions of the wearable device, and wherein the one or more processing circuits are configured to identify the one or more actions performed by the operator by:
determining, based on a location of the one or more second positions of the wearable device relative to one or more second portions of the vehicle, one or more components of the vehicle proximate to the one or more second positions;
identifying, based on the one or more components, a plurality of given actions associated with the one or more components; and
determining, based on an amount of time spent at the one or more second positions of the wearable device, one or more given actions of the plurality of given actions associated with the amount of time.

16. The vehicle of claim 9, wherein the wearable device is included in at least one of a hardhat, a high visibility article of clothing, a watch, a band, a strap, or a pin.

17. The vehicle of claim 9, the one or more processing circuits further configured to:
determine, based on the one or more actions, that the one or more actions include at least one evaluated action;
generate, responsive to determination that the one or more actions include the at least one evaluated action, an indication of performance of the at least one evaluated action; and
provide, to the wearable device, the indication of the performance of the at least one evaluated action;
wherein the at least one evaluated action includes at least one of:
inspecting fasteners coupling tractive elements to the vehicle;
inspecting the vehicle for foreign objects;
inspecting lighting equipment disposed on the vehicle;
performing an equipment function test; or
locating identification information disposed on the vehicle.

18. A position tracking system for a vehicle, comprising:
a first position module coupled with a first portion of the vehicle;
a second position module included in a wearable device, and the wearable device configured to be positioned on an operator of the vehicle; and
one or more processing circuits in communication with the first position module and the second position module, the one or more processing circuits configured to:
receive a plurality of signals corresponding to communications between the first position module and the second position module;
determine, based on the plurality of signals, a position of the wearable device;
detect, responsive to receipt of a second plurality of signals corresponding to subsequent communication between the first position module and the second position module, a change in the position of the wearable device;
identify, based on the change in the position of the wearable device, one or more actions performed by the operator; and
determine, based on the one or more actions, that at least one evaluated action is included in the one or more actions.

19. The position tracking system of claim 18, further comprising:
a third position module disposed on a moveable component of the vehicle; and
the one or more processing circuits further configured to:
receive a third plurality of signals corresponding to communications between the first position module and the third position module;
determine, based on the third plurality of signals, a first position of the wearable device relative to the moveable component of the vehicle; and
prevent, responsive to a change in the first position of the wearable device, operation of the moveable component.

20. The position tracking system of claim 18, the one or more processing circuits further configured to:
determine, based on the one or more actions, that at least one second evaluated action is absent from the one or more actions; and
transmit, responsive to determination that the at least one second evaluated action is absent from the one or more actions, a signal to the second position module to cause the wearable device to produce at least one of audible feedback, haptic feedback, or visual feedback to alert the operator.
